(19) United States
(12) Patent Application Publication
(10) Pub. No.: US 2026/0275794 A1
(43) Pub. Date: Sep. 17, 2026

(54) GARAGE MOTOR CONTROL AND GARAGE SAFETY SENSORS SYSTEM

(71) Applicant: M&R Technology, Inc., San Diego, CA (US)

(72) Inventors: Jerker TAUDIEN, Shelburne, VT (US); Magid FAZEL, San Diego, CA (US); David WHITFIELD, Cummings, GA (US)

(21) Appl. No.: 19/553,047

(22) Filed: Feb. 27, 2026

Related U.S. Application Data
(60) Provisional application No. 63/771,081, filed on Mar. 13, 2025.

(51) Int. Cl. E05F 15/40; G01D 5/16; G01V 8/12

(52) U.S. Cl. CPC E05F 15/40; G01D 5/16; G01V 8/12; E05Y 2400/354; E05Y 2400/54; E05Y 2400/654; E05Y 2400/66; E05Y 2900/106

(57) ABSTRACT

Disclosed is a smart garage sensor and controller system. According to some implementations, the system includes a light curtain safety sensor comprising a transmitter unit with a plurality of transmitter LEDs and a receiver unit with a plurality of receiver modules, a smart wall button, and a status light module. The light curtain creates a dense coverage of the garage door opening which is advantageous for obstacle detection purposes. A WiFi enabled device can control (open or close) the garage door through the smart wall controller. Further the smart wall controller can communicate to the WiFi enabled device if the garage door is at least partially open (security issue) and if the garage door is fully open (ready to back out a car). The status light communicates to a car driver the state of the garage door to aid with parking in a garage.

### RELATED APPLICATIONS

This application claims priority to U.S. Provisional Application No. 63/771,081, filed 13 Mar., 2025, and which is incorporated herein in its entirety by reference.

### TECHNICAL FIELD

Embodiments of the disclosure are directed to the field of a garage system comprising sensor, controller, and status signaling devices, and how such devices are partitioned to form a smart garage system.

### BACKGROUND OF THE DISCLOSURE

Smart-home technology is becoming increasingly popular each year and many homes are outfitted with smart-home technology such as lights, window shades, locks, that can be controlled wirelessly. However, the deployment of smart-home technology in garages is much less common, which may be due to the long-life cycle of existing garage door openers (GDOs), and high upgrade cost. Many new GDOs do contain smart-garage technology, but the rate at which they are deployed is slow and it could take several decades until a significant portion of garages are smart-garage capable.

A quicker approach to deploy smart-garage technology is to retrofit existing GDOs with add-on smart technology such as using WiFi to open and close the garage door, sensing if the door is open, and integration with home-automation systems. There exist conventional add-on products that enable WiFi control of garage doors that can also sense if the door is open. Some of those add-on products claim to be universally compatible and others are designed to work with only one brand of GDOs.

A motorized overhead garage-door system is shown in FIG. 1. Entry to a garage is through an opening 101 and the opening can be closed by a garage door 102. The garage-door opener (GDO) 103 can open and close the garage door 102. The GDO 103 has a safety-sensor interface 104 that comprises power and control to a transmitter safety sensor 105 and receiver safety sensor 106. The pair of transmitter and receiver safety sensors form a single beam 107 that senses obstacles in the way of a closing garage door 102. The GDO 103 stops the motion of the garage door 102 while it is in a closing state if an obstacle blocks the single beam 107.

A wall controller 108 with a push button 109 is connected to the GDO 103 through a wall-controller interface 110 comprising power and control. The push button 109 is used to signal to the GDO to open or close the garage door 102. Additionally, many garage-door systems also include a wireless remote control 111 with a remote button 112 that communicates with the GDO through a wireless interface 113 to open or close the garage door. The GDO is powered from an alternating current (AC) power source 114.

A conventional add-on garage WiFi controller 115 is powered from the AC power source 114. The add-on garage WiFi controller 115 communicates through WiFi 116 to a WiFi enabled device 117. This device 117 can be a smart phone, a home-automation system, a server, or any other WiFi, Ethernet, or wireless capable device. The add-on WiFi controller 115 can sense the state of the garage door (open or closed) through either a wireless connection 118 to a tilt sensor 119 that is mounted on a garage-door panel, or through a wired connection 120 to a reed switch 121 activated by a magnet 122 mounted on the garage door 102. One drawback of using a tilt sensor 119 or a reed switch 121 is that there is a threshold for differentiating between sensing a closed or an open door and it may not be possible to sense if the door is slightly open or fully open. It is advantageous to be able to determine both if the door is not closed (useful for security purposes) and if the door is fully open (to determine if it is safe to back out a car). Typically, add-on garage WiFi controllers 115 select to sense if the garage door 102 is slightly open, forgoing the ability to sense if it is fully open. Additional disadvantages of a tilt sensor 119 to sense the door state are the additional hardware cost and installation time; and battery replacement. Additional disadvantages of the reed switch 120 to sense the door state are the additional hardware cost and installation time; and the additional wiring from the add-on garage WiFi controller 115. The device 117 can communicate over WiFi 116 to the add-on garage WiFi controller 115 to open or close the garage door 102.

There are several shortcomings of existing add-on garage WiFi controllers 115, including: cumbersome installation process requiring wiring the add-on garage WiFi controller 115 to the GDO 103 that is typically located close to the garage ceiling; requiring an AC power source 114 which means additional wiring; inability to sense if the single beam 107 is blocked; and inability to sense if the garage door is fully open.

### SUMMARY

According to some implementations, a smart garage sensor and controller system is disclosed. The system may include a light curtain safety sensor comprising a transmitter unit with a plurality of transmitter LEDs and a receiver unit with a plurality of receiver modules, a smart wall button, and a status light module.

According to some implementations, the light curtain creates a dense coverage of the garage door opening which is advantageous for obstacle detection purposes.

According to some implementations, a WiFi enabled device can control (open or close) the garage door through the smart wall controller. Further the smart wall controller can communicate to the WiFi enabled device if the garage door is at least partially open (security issue) and if the garage door is fully open (ready to back out a car).

According to some implementations, the status light communicates to a user (e.g, a vehicle driver) the state of the garage door to aid with parking in a garage.

According to some implementations, a garage door controller is disclosed. The garage door controller includes indication circuitry configured to indicate state information indicative of one or more states associated with a garage door, a wireless communication interface configured to wirelessly communicate the state information to a user device, and a wired connection to a garage door opener (GDO), wherein power for powering the indication circuitry and the wireless communication interface is provided through the wired connection to the GDO.

According to some implementations, the wireless interface supports WiFi communication. According to some implementations, the wireless interface supports one or more of Bluetooth, Bluetooth Low Energy (BLE), Thread, Zigbee, Z-Wave.

According to some implementations, the wired connection is electrically coupled directly to the GDO. According to some implementations, power is provided to the garage door controller exclusively through the wired connection to the GDO. According to some implementations, the power provided is less than 1 W.

According to some implementations, the garage door controller includes a compatibility setting module that is configured to provide for universal control of multiple GDOs from different manufacturers.

According to some implementations, the wireless communication interface is configured to receive an indication of a garage door state from a garage door safety sensor system.

According to some implementations, the garage door safety sensor system includes a light curtain including a plurality of transmitter units and a plurality of receiver units.

According to some implementations, the garage door safety sensor system includes a light beam receiver including a receiver aperture configured to detect reflection of light from a garage door. According to some implementations, the indication circuit is configured to determine one or more garage door states based on the detected reflection for the light beam receiver.

According to some implementations, the indication circuitry is configured to indicate a garage door open state and a garage door closed state.

According to some implementations, the indication circuit is configured to indicate a garage partially open state, a garage sufficiently open state, and a garage door obstructed state.

### BRIEF DESCRIPTION OF THE DRAWINGS

FIG. 1 shows a conventional add-on garage WiFi controller system.

FIG. 2 shows an example implementation of a smart garage sensor and controller system comprising a smart wall controller, a light curtain safety sensor, and a status light module.

FIGS. 3A-3C show example implementations of a door state sensor comprising LED and receiver module base technology.

FIGS. 4A-4B show example implementations of a door state sensor comprising magnetic sensing technology.

FIG. 5 shows an example implementation of a smart garage system comprising a GDO with built-in smart technology, a light curtain safety sensor, and a status light module.

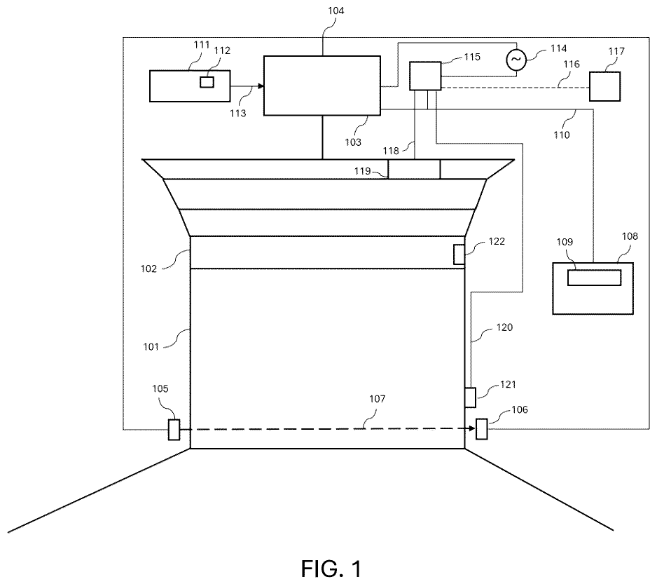

### DETAILED DESCRIPTION OF THE EMBODIMENTS

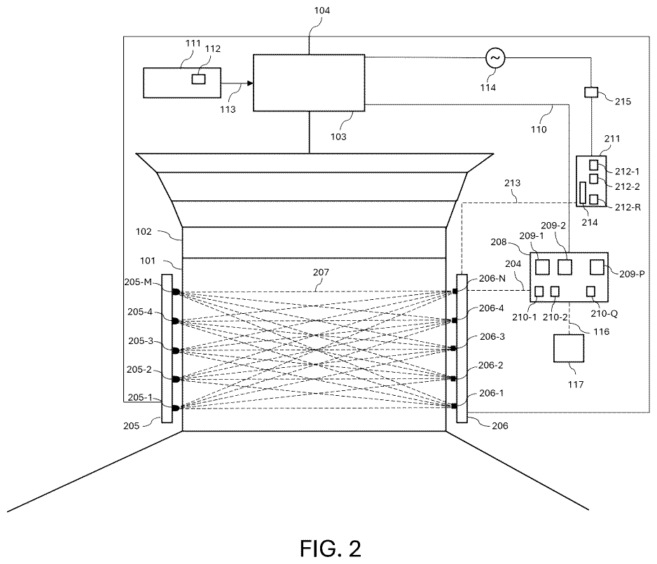

According to some embodiments, a smart garage sensor and controller system is disclosed and is shown in FIG. 2. The system includes a light curtain safety sensor comprising a transmitter unit 205 with M transmitter LEDs 205-1 through 205-M and a receiver unit 206 with N receiver modules 206-1 through 206-N, a smart wall controller 208, and a status light module 211. The number of transmitter modules M and receiver modules N can each be any number greater than or equal to 1. For the case M=N=1, the light curtain turns into a single beam sensor. This case shall be included as an example of the light curtain throughout this disclosure. The smart wall controller 208 replaces the conventional wall controller 108; the light curtain safety sensor transmitter unit 205 and receiver unit 206 replace the transmitter and receiver safety sensors 105-106; and the status light module 211 is an add-on component.

The light curtain comprising the transmitter unit 205 and receiver unit 206 form M times N light-curtain beams 207, providing multi-beam coverage of the garage opening 101. In some embodiments, the multi-beam coverage allows for detection based on the density of the multiple light-curtain beams, based on individual beams of the individual beams of the multiple light-curtain beams, or a combination thereof. Multi-beam coverage is advantageous over the single beam 107 because obstacle detection is greatly improved. A light curtain safety sensor can detect protruding bumpers, open hatches, hitches, bicycles, etc., preventing damage by instructing the GDO 103 to not close the garage door 102.

In some embodiments, the light curtain receiver unit 206 can determine precisely which beam or beams are blocked as a function of time. The spatiotemporal beam blocked information can be used to train artificial intelligence (AI) or machine learning (ML) models to recognize objects including cars, trunks, bumpers, humans, pets etc. crossing the garage opening 101.

The smart wall controller 208 comprises P buttons 209-1 through 209-P, where P can be any number greater than or equal to 1. The functionality of the buttons 209-1 through 209-P includes but is not limited to opening and closing the garage door 102, opening and closing multiple garage doors, and turning on a light in the GDO. In some embodiments, the system includes Q status lights 210-1 through 210-Q in the smart wall controller 208, of which each light can indicate a state of the smart garage system. The number of status lights Q can be any number greater than or equal to zero.

The smart garage controller 208 communicates through a wireless interface 116 to a device via a wireless connection. In some embodiments, the device may include a smart home hub or smart home controller that supports standards based or proprietary communication protocols. In other embodiments, the device may include a user device, such a cellular phone, a smart assistant device, or the like. The wireless interface may include WiFi, Ethernet, Thread, Bluetooth, Bluetooth Low Energy (BLE), Zigbee, Z-Wave or any other standardized or proprietary protocol. The device 117 can be a smart phone, a home-automation system, a server, or any other WiFi, Ethernet, or wireless capable device. The device 117 can control (open or close) the garage door 102 through the smart wall controller 208. Further, the smart wall controller 208 can communicate to the device 117 in various states of the garage door. These states include, but are not limited to, if the garage door is at least partially open (e.g., indicating a security issue), if the garage door is fully open (e.g., indicating that the system is ready to back out a car), if any of the light-curtain beams 207 are blocked, and classification of any objects blocking the light-curtain beams 207. The smart wall controller 208 receives the state of the garage door through a wireless interface 204 from the receiver unit 206. The wireless interface 204 can be implemented over Bluetooth, Bluetooth Low Energy (BLE), Thread, Zigbee, Z-Wave or any other standardized or proprietary wireless protocol.

The GDO 103 safety-sensor interface 104 and wall controller interface 110 may include two wires each but can include any number of wires. In the non-limiting example of a two-wire system, the two wires of the safety-sensor interface 104 may be routed to both sides of the garage opening 101. The two neutral wires to both sides may be tied together in the GDO 103 and the two positive wires to both sides may be tied together in the GDO 103. In some embodiments, the wires to the transmitter side may only be used to power the transmitter safety sensor 105 or light curtain transmitter unit 205. In some embodiments, the wires to the receiver side may be used both for powering the receiver safety sensor 106 or light curtain receiver unit 206 and for communication to the GDO 103 about the blocked or not blocked state of the single beam 107 or light curtain beams 207.

According to some implementations, the two wires of the wall controller interface 110 comprise a neutral and a positive wire. The interface provides power to the wall controller 108 and smart wall controller 208. The two wires may also be used for communication to the GDO 103 to open or close the garage door. In some implementations, the neutral and positive wires are shorted together when the push button 109 is pushed and the GDO 103 senses the drop in voltage on the positive wire and then takes the action to open or close the garage door 102. Other more complex protocols and implementations may also be supported to communicate to the GDO 103 to turn on or off a light, change a configuration in the GDO 103, and change a configuration in the wall controller 108. Different models of GDOs 103 may utilize different communication protocols through the wall controller interface 110. The smart wall controller 208 implements one or more of the existing communication protocols on the wall controller interface 110, such that it supports some or all the functionality of the wall controller 108 that it replaces. The specific model of the replaced wall controller 108 can be configured in the smart wall controller 208 or through the device 117. The specific model of the replaced wall controller 108 may in some cases be learned by sending a sequence of signals through the wall controller interface 110 and detecting the response from the GDO 103.

In certain aspects, the GDO 103 safety-sensor interface 104 and wall-controller interface 110 provide low power. By low power in the context of the present disclosure it is approximately meant power of <1 W, or <500 mW, or <200 mW. The low power available on the interfaces 104 and/or 110 is used to power the light curtain safety sensor transmitter unit 205, the receiver unit 206, and the smart wall controller 208. There are significant advantages to using power from the GDO 103 to avoid additional wiring to AC power sources 114, which may be scarce in many garages. Requiring AC power may limit the positioning of the safety sensor light curtain and smart wall button and/or would require long and cumbersome wiring.

The wireless communication implementation in the smart wall controller 208 may require more power than what is available from the GDO 103 through the wall-controller interface 110. The required peak power may be higher than the available power for some limited duration and the average power may be less than what is available. In some implementations, an energy storage device is provided. The energy storage device may be a battery, rechargeable battery, capacitor, super capacitor, or any other energy storage device to store energy that can be made available to provide high peak power for limited durations. The average power required by the wireless communication implementation in the smart wall controller 208 may be less than the average power available from the GDO 103 through the wall-controller interface 110.

The status light module 211 may be AC powered, battery powered, or may be integrated into the smart wall controller 208 and powered from the wall-controller interface 110.

According to some embodiments, the receiver unit 206 communicates the sensed states to a status light module 211 over a wireless interface 213. The wireless interface 213 can be implemented over Bluetooth, Bluetooth Low Energy (BLE), Thread, Zigbee, Z-Wave or any other standardized or proprietary wireless protocol. The status light module comprises R status lights 212-1 through 212-R, where R can be any number greater or equal to 1. The state of the status lights 212-1 through 212-R may be set based on the light curtain safety sensor state and the garage door fully open state. One such, non-limiting example of a mapping could be:
Red: the garage door 102 is not fully open;
Green: the garage door 102 is fully or sufficiently open and there is no blockage sensed by the light curtain receive unit 206;
Yellow: the garage door 102 is fully open or sufficiently open and there is a blockage sensed by the light curtain receiver unit 206.
   Other mappings of sensed door and safety-sensor state to the status light state may also be possible. Additionally, some or all of the status lights 210 (e.g., 210-1 through 210-Q) in the smart wall controller 208 may be arranged to provide the same or a similar indication function as the status lights 212-1 through 212-R.

The status light module 211 may be powered from the AC power source 114, from an energy storage device 214. The energy storage device 214 may be a battery, rechargeable battery, capacitor, super capacitor, or any other energy storage device. The energy storage device 214 may be charged directly or indirectly from the AC power source 114. One indirect charging method may be to charge the energy storage device 214 from the AC power source 114 through an AC to direct current (DC) converter 215. The AC to DC converter 215 may be a USB power supply providing 5 VDC to the status light module 211 or any other AC to DC converter. The AC to DC converter 215 is optional and the status light module 211 may be powered directly from the AC power source 114. The energy storage device 214 may be charged from the AC power source 114 at times when the energy of the energy storage device 214 is below some threshold. When the energy of the energy storage device is above some other threshold, the status light module 211 may be disconnected from the AC power source or AC to DC converter.

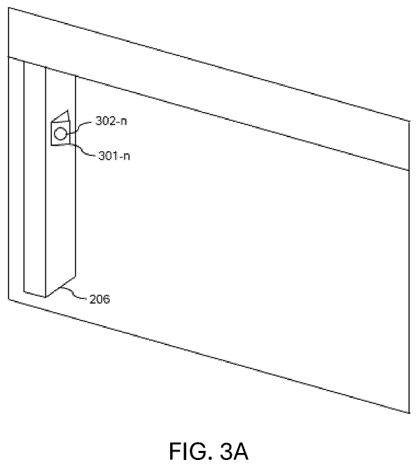

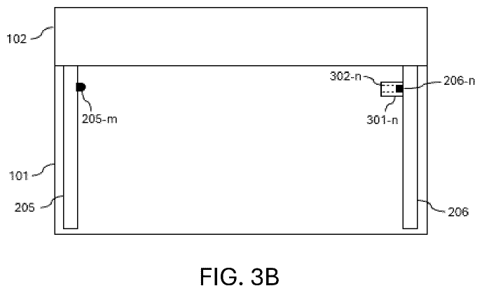

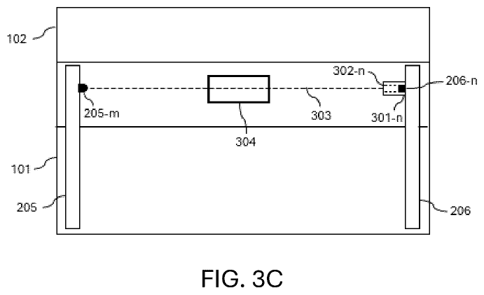

According to some embodiments, a door state sensor is disclosed and is shown in FIG. 3A through FIG. 3C. The light curtain receiver unit 206 has an aperture unit 301-n and an aperture slot 302-n containing the receiver module 206-n. In some embodiments, the aperture unit 301-n and aperture slot 302-n may be provided as one of the plurality of receiver modules 206-n or may be provided as a separate unit from the receiver module 206-n. The variable n can be in the range 1 through N. The aperture unit 301-n and aperture slot 302-n are shaped such that there is substantially no direct path response between the transmitter LED 205-m, where the variable m can be in the range 1 through M, and the receiver module 206-n. The angle of the aperture 302-n may be oriented at a pre-defined angle relative to the central axis of a transmission beam (e.g., 207, FIG. 2) from a transmitter LED 205- m. For example, the angle may be in the range of 5 to 60 degrees. The angle of the aperture 302-n serves to limit the aperture unit 301-n's field of view, effectively blocking light beams that are not reflected from garage door 102. The aperture unit 301-n may, in some embodiments, include lenses or filters to further refine and/or filter the incoming light signals and to improve detection accuracy.

FIG. 3B shows an example where there is no response between the transmitter LED 205-m and the receiver module 206-n when the garage door 102 is in a vertical position above the horizontal line formed between transmitter LED 205-m and receiver module 206-n. In FIG. 3C, the vertical position of the garage door 102 is lower than in FIG. 3B such that the bottom of the garage door 102 is below the horizontal line formed between transmitter LED 205-m and receiver module 206-n. Now, there is a response 303 between the transmitter LED 205-m and the receiver module 206-n through a reflection from the garage door 102. A response in this context may mean that the irradiance measured in W/m² at the receiver module 206-n due to a radiant intensity produced by the transmitted LED, measured in W/sr, exceeds a threshold irradiance Eₘᵢₙ. The reflectivity of the garage door 102 may vary depending on the material that the garage door 102 is made of. An optional reflector 304 may be placed on the garage door 102 to enhance or control the reflectivity.

The open state of the garage door may be determined based on the measured irradiance at the receiver module 206-n. Multiple receiver modules, aperture units 301-n, and aperture slots 302-n, n={1, 2, . . . , N} may be used to determine multiple door states. For example, N=2, and transmitter LED and receiver module pair 1 placed at the bottom of the transmitter unit 205 and receiver unit 206, respectively and transmitter LED and receiver module pair 2 placed at the top of the transmitter unit 205 and receiver unit 206, respectively, could be used to sense if the garage door 102 is at least partially open and if the garage door 102 is fully open. Partially open in this context means that the bottom of the garage door 102 is above the horizontal line between the transmitter LED and the receiver module pair 1. Fully open in this context means that the bottom of the garage door 102 is above the horizontal line between the transmitter LED and the receiver module pair 2. Another number of pairs may be utilized to sense additional garage door states, including, for example: whether the garage door is sufficiently open to back out a vehicle (e.g., a garage door sufficiently open state), the garage door is partially open (e.g., a garage door partially open state, thus creating a security risk), and/or whether there is a detected obstruction in the path of the garage door closing.

Some embodiments may include the transmitter LED 205-m in an aperture slot of an aperture unit and the receiver module 206-n without an aperture unit and aperture slot. The functionality of this alternative embodiment may be the same as that of the embodiment previously disclosed.

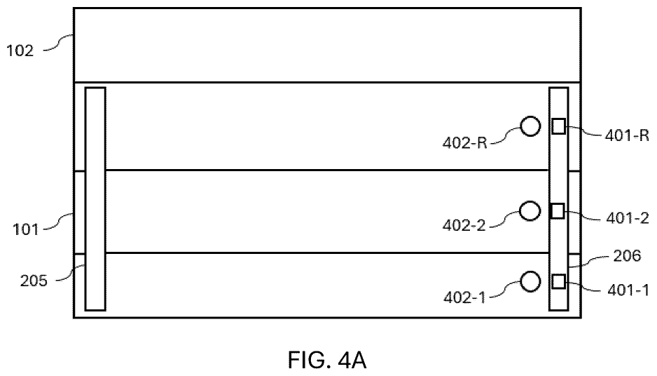

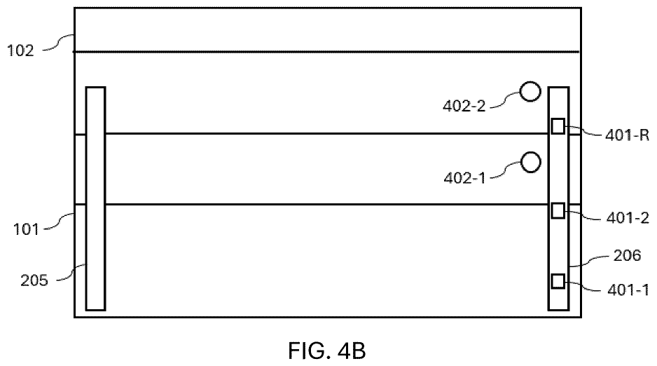

According to some embodiments, a door state sensor is disclosed and is shown in FIG. 4A through FIG. 4B. In the examples of FIGS. 4A and 4B, the light curtain receiver unit 206 includes magnetic field sensors 401-1 through 401-R, where R may be a set corresponding to any number greater than or equal to 1. On the garage door 102, R magnets 402-1 through 402-R are mounted at vertical positions substantially equal to the vertical positions of the magnetic field sensors 401-1 through 401-R. The magnetic field sensors may be using anisotropic magneto resistance (AMR) technology, tunneling magnetoresistance (TMR) technology or any other technology. One constraint is that the maximum magnetic field generated by the magnet at the farthest expected distance is significantly greater than earth's magnetic field in order to sense the proximity of the magnets.

The magnetic field sensors 401-1 through 401-R can thus be configured to monitor an open/close state of the garage door 102 based on the detection of the magnets 402-1 through 402-N. The indication circuitry in the smart wall controller 208 can thus identify that the garage door 102 is closed based on each of the magnetic field sensors 401-1 through 401-R detecting the respective one of the magnets 402-1 through 402-R, such as demonstrated in the example of FIG. 4A. The indication circuitry can thus monitor changes in state of the detection (e.g., via counters, latches, or other logic) associated with each of the magnetic field sensors 401 to determine partial open to full open states of the garage door 102.

In the example of FIG. 4B, the indication circuitry can identify that the garage door 102 is partially open based on the position of the magnets 402 relative to the magnetic field sensors 401. For example, in the case of R=3, while none of the magnetic field sensors 401 detect a given one of the magnets 402, the indication circuitry can identify the approximate partial open state of the garage door based on the quantity of magnets 402 detected by the magnetic field sensors 401 based on the initial state of the garage door 102 as fully open or fully closed. Accordingly, the smart wall controller 208 can provide the appropriate indication via the indicator lights 210 and/or 212, and/or to the device 117 (e.g., including any or all of the garage door fully open, fully closed, partially open, or sufficiently open states). As a result, the use of the magnetic field sensors 401 with the magnets 402 can provide an additional safety feature associated with providing a user with knowledge of the open or closed state of the garage door 102, such as in combination with the light curtain safety sensor.

It should be recognized that, according to some embodiments, significant synergy may be obtained by combining a light curtain transmitter unit 205 and receiver unit 206 with a status light module 211. This combination can be used as a parking sensor that visually indicates to the driver if the car is parked sufficiently far into the garage to interfere with the closing of the garage door 102. Additionally, the space in a garage may be barely large enough to park a car, in which case it is useful to be able to know precisely when the rear of the car (assuming head-in parking) passes the garage opening 101 to avoid colliding with the front wall of the garage.

Further, it should be recognized that, according to some embodiments, significant synergy may be obtained by the wireless interface 204 between the receiver unit 206 and the smart wall controller 208. All or substantially all desired measured values and garage door states (blocked beams, garage door 102 at least partially open, garage door 102 fully open, and classified objects blocking the door opening 101) that are sensed by the receiver unit 206 can be communicated through the smart wall controller 208 to the device 117.

Embodiments may comprise a subset of the parts disclosed in FIG. 2. For example, an alternative embodiment may include the light curtain transmitter unit 205 and light curtain receiver unit 206 and the status light module 211. Another alternative embodiment may include the light curtain transmitter unit 205 and light curtain receiver unit 206 and smart wall controller 208. Another alternative embodiment may include a transmitter unit 205 and receiver unit 206 with only one beam 207 and a smart wall controller 208. Any combination of the disclosed embodiments may constitute an alternative embodiment.

Some embodiments may also use the wireless interface 113 for communication between the smart wall controller 208 for opening and closing the garage door 102.

The garage door safety system may include a compatibility setting module configured to support compatibility with garage door openers (GDOs) from various manufacturers through adaptable hardware and software configurations. In one embodiment, the system includes selectable hardware switch settings, such as DIP switches, jumpers, or rotary selectors, that allow users or installers to manually configure the system for compatibility with different GDO models. These hardware settings may adjust signaling protocols, voltage levels, or timing parameters to ensure proper communication between the smart garage door controller and the connected GDO.

Alternatively or additionally, the system may support software-based configuration through firmware programming or a companion mobile or desktop application. The smart garage door controller may include a microcontroller or processor capable of running configurable firmware that can be updated or modified to support various GDO protocols. A user, installer, or manufacturer application may facilitate the selection of the appropriate manufacturer and model, transmitting configuration data wirelessly via Bluetooth, Wi-Fi, or another communication protocol to the controller.

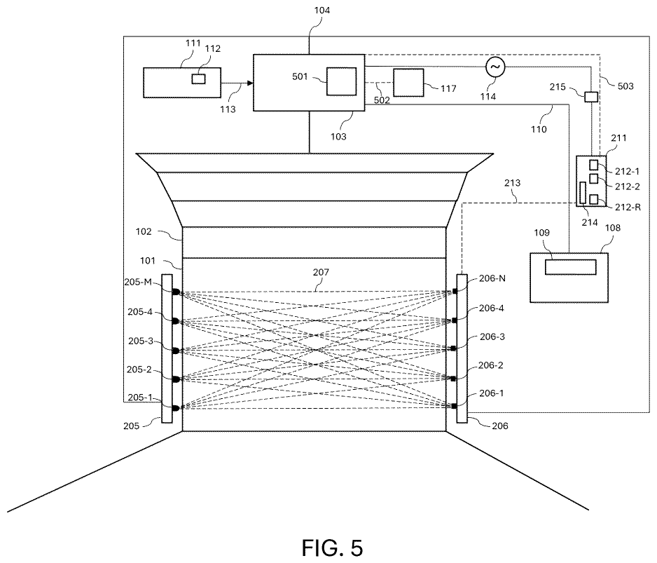

For GDOs that contain smart-garage technology, including WiFi to open and close the garage door, and integration with home-automation systems, there are significant benefits of adding features of the previously disclosed technology. According to some embodiments, a smart-garage system is disclosed and is shown in FIG. 5. The GDO 103 has a built-in smart technology module 501 that communicates through WiFi 502 to a WiFi enabled device 117. The WiFi enabled device 117 can open and close the garage door by sending commands through WiFi 502. The wireless interface 503 between the GDO 103 and the status light module 211 is used to communicate garage door states (blocked beams, garage door 102 at least partially open, garage door 102 fully open, and classified objects blocking the door opening 101). The blocked beam state may be communicated from the GDO through the wireless interface 503 or from the receiver unit 206 through the wireless interface 213 to the status light module 211.

Conventional smart-garage technology GDO systems with a single beam 107 cannot sense if there is a blockage of the garage door anywhere other than in a line formed between the transmitter safety sensor 105 and receiver safety sensor 106. Therefore, such systems are not suitable for obstacle detection purposes. Obstacle detection is desirable from a safety standpoint and for parking sensing.

Parking sensing of the embodiment in FIG. 5 is enabled by the light curtain comprising the transmitter unit 205 and receiver unit 206 that provide dense coverage of the garage door opening; and the status light module 211.

There is significant synergy by combining a smart-garage technology GDO with a light curtain. The light curtain beams 207 can sense a blockage state and the GDO 103 is inherently aware of the door state (garage door 102 at least partially open and garage door 102 fully open). These states are communicated from the GDO 103 through the wireless interface 503 to the status light modules 211. The state of the status lights 212-1 through 212-R may be set based on the light curtain safety sensor state and the garage door state.

The garage door safety system described herein, including each of any described modules, may be implemented using various hardware and software architectures, including different configurations of sensors, processing units, and control circuitry. The system may include one or more LED-based sensors configured to detect objects, movement, or environmental conditions in proximity to the garage door. These sensors may operate using infrared, visible light, or other optical principles and may be positioned along the door track, at the door's base, or in other strategic locations. While the system is described as employing LED-based sensors, it is not limited thereto, and other types of sensors, such as laser-based, photodiode, or other optical or non-optical detection technologies, may be used in alternative implementations.

The sensors may communicate with a smart garage door controller, which may be implemented using a microcontroller, application-specific integrated circuit (ASIC), field-programmable gate array (FPGA), or other suitable processing unit. The smart garage door controller may include an embedded processor, memory, and input/output interfaces for managing sensor data, executing control algorithms, and facilitating communication with external devices. The hardware circuitry may incorporate analog and digital signal processing components, including amplifiers, analog-to-digital converters (ADCs), digital-to-analog converters (DACs), voltage regulators, and power management circuits to ensure reliable operation. Additionally, communication between system components may be established using wired connections, such as serial, I2C, or SPI interfaces, or wirelessly via protocols such as Bluetooth, Wi-Fi, or Zigbee.

The system may further include fail-safes, redundancy mechanisms, and error-checking circuitry to enhance reliability and prevent malfunctions. Additionally, memory storage, such as flash memory or EEPROM, may be used to store firmware, calibration data, or user-defined preferences. The garage door controller may be integrated with existing home automation systems or cloud-based platforms, enabling remote access, monitoring, and control via mobile applications or other networked devices. While specific implementations are described, it will be understood that alternative configurations, circuit designs, sensor types, and processing architectures may be utilized without departing from the scope of the present disclosure.

It will be appreciated by those skilled in the art that various modifications and changes may be made without departing from the scope of the described technology. Such modifications and changes are intended to fall within the scope of the embodiments. It will also be appreciated by those of skill in the art that features included in one embodiment are interchangeable with other embodiments; and that one or more features from a depicted embodiment can be included with other depicted embodiments in any combination. For example, any of the various components described herein and/or depicted in the figures may be combined, interchanged, or excluded from other embodiments.

What is claimed is:

1. A garage door controller comprising:
indication circuitry configured to indicate state information indicative of one or more states associated with a garage door;
a wireless interface configured to wirelessly communicate the state information to a user device; and
a wired connection to a garage door opener (GDO) to provide power to the indication circuitry and the wireless interface from the GDO.

2. The garage door controller of claim 1, wherein the wireless interface supports WiFi communication.

3. The garage door controller of claim 1, wherein the wireless interface supports one or more of Bluetooth, Bluetooth Low Energy (BLE), Thread, Zigbee, or Z-Wave.

4. The garage door controller of claim 1, wherein the wired connection is electrically coupled directly to the GDO.

5. The garage door controller of claim 1, further comprising a compatibility setting module, wherein the compatibility setting module is configured to provide for universal control of multiple GDOs from different manufacturers.

6. The garage door controller of claim 1, wherein the wireless interface is further configured to receive an indication of a garage door state from a garage door safety sensor system.

7. The garage door controller of claim 6, wherein the garage door safety sensor system comprises a light curtain including a transmitter unit and a receiver unit.

8. The garage door controller of claim 6, wherein the garage door safety sensor system comprises a light beam receiver including a receiver aperture configured to detect reflection of light from a garage door, and wherein the indication circuitry is configured to determine one or more garage door states based on the detected reflection for the light beam receiver.

9. The garage door controller of claim 6, wherein the garage door safety sensor system comprises one or more magnetic field sensors and one or more magnets, wherein the garage door safety sensor system is configured to determine the state information as at least one of a garage door open state, a garage door closed state, a garage partially open state, or a garage sufficiently open state based on a relative detection of the one or more magnets via the one or more magnetic field sensors.

10. The garage door controller of claim 1, wherein the indication circuitry is configured to indicate a garage door open state and a garage door closed state.

11. The garage door controller of claim 1, wherein the indication circuitry is configured to indicate a garage partially open state, a garage sufficiently open state, and a garage door obstructed state.

12. The garage door controller of claim 1, further comprising a status light module comprising one or more status lights, wherein a state of the one or more status lights is configured to be set based on the one or more states associated with the garage door.

13. A status light module comprising:
a wireless interface configured to wirelessly communicate state information indicative of one or more states associated with a garage door; and
one or more status lights, wherein a state of the one or more status lights is configured to be set based on the one or more states associated with the garage door.

14. The status light module of claim 13, wherein the wireless interface is connected to a light curtain receiver unit.

15. The status light module of claim 13, wherein the wireless interface is electrically connected to a garage door opener (GDO).

16. The status light module of claim 13, wherein the wireless interface supports one or more of Bluetooth, Bluetooth Low Energy (BLE), Thread, Zigbee, Z-Wave.

17. The status light module of claim 13, wherein the wireless interface is further configured to receive an indication of the one or more states associated with the garage door from a garage door safety sensor system.

18. The status light module of claim 17, wherein the garage door safety sensor system comprises a light curtain including a transmitter unit and a receiver unit.

19. The status light module of claim 13, wherein states of the one or more status lights are set based on a garage sufficiently open state and a garage door obstructed state.

20. A garage door controller comprising the status light module of claim 13, the garage door controller further comprising:
indication circuitry configured to indicate the state information indicative of the one or more states associated with the garage door; and
a wired connection to a garage door opener (GDO) to provide power to the indication circuitry and the wireless interface from the GDO.
